(19) United States
(12) Patent Application Publication
(10) Pub. No.: US 2009/0193849 A1
(43) Pub. Date: Aug. 6, 2009

(54) METHOD FOR STABILIZING SLAG AND NOVEL MATERIALS PRODUCED THEREBY

(75) Inventor: Sang-Yoon Oh, Seoul (KR)

Correspondence Address: RENNER OTTO BOISSELLE & SKLAR, LLP, 1621 EUCLID AVENUE, NINETEENTH FLOOR, CLEVELAND, OH, 44115, US

(73) Assignee: Ecomaister Co., Ltd., Incheon (KR)

(21) Appl. No.: 12/304,583

(22) PCT Filed: Jun. 14, 2006
(86) PCT No.: PCT/KR2006/002259

§ 371 Date: Dec. 12, 2008

(51) Int. Cl. C04B 5/02

(52) U.S. Cl. 65/19

(57) ABSTRACT

Disclosed herein is a method for stabilizing slag, which is an oxide byproduct generated after completion of refining in a converter process for converting molten iron into molten steel via de-carbonization or in an electric arc furnace process for producing molten steel via melting of scrap iron, during iron/steel making processes, and a novel material produced thereby. More particularly, disclosed is a method for stabilizing and recycling slag, wherein converter slag or electric arc furnace slag, which is difficult to recycle because of free lime (i.e. free calcium oxide (CaO) referring to single-phase CaO) remaining therein after cooling, is subjected to appropriate treatments after completion of converter blowing, thereby restricting generation of free lime, and consequently, minimizing differentiation/expansion, environmental pollution and instability of slag. The method for stabilizing slag includes allowing molten slag to fall, injecting high-pressure gas to falling molten slag to separate the molten slag into fine droplets, and quenching the fine droplets with the injected gas and surrounding atmosphere.

### TECHNICAL FIELD

The present invention relates to a method for stabilizing slag, which is an oxide byproduct generated after completion of refining in a converter process for converting molten iron into molten steel via de-carbonization or in an electric arc furnace process for producing molten steel via melting of scrap iron, during iron/steel making processes, and a novel material produced thereby. More particularly, the present invention relates to a method for stabilizing and recycling slag wherein converter slag or electric arc furnace slag, which is difficult to recycle because of free lime (i.e. free calcium oxide (CaO) referring to single-phase CaO) remaining therein after cooling, is subjected to appropriate treatments after completion of converter blowing, thereby restricting generation of free lime, and consequently, minimizing differentiation/expansion, environmental pollution and instability of slag.

### BACKGROUND ART

A converter refining process is performed for converting molten iron into molten steel. In the converter refining process, molten iron, which is conveyed directly from a blast furnace or passed through an appropriate pre-treatment, is loaded into a converter along with several main/sub raw materials, and thereafter, high-speed oxygen is blown to the loaded molten iron. A primary object of the refining process is to remove carbon saturated in molten iron via an oxidation reaction between the carbon and oxygen, so as to obtain molten steel suitable for use in finished steel products. In addition to this primary object, the refining process has other important objects for controlling contents of impure components, such as sulfur, phosphor, etc., within appropriate ranges and for obtaining desired physical properties of slag. To accomplish the above mentioned latter object, in particular, it is necessary to maintain a higher content of CaO in converter slag than blast furnace slag. For this, conventionally, a large amount of sub raw materials capable of supplementing CaO, such as lime, dolomite, fluorite, or the like, are poured into slag at an appropriate time point in the course of blowing. As a result, the slag, which remained in a converter after completion of the blowing, contains a large amount of CaO.

Although having slight differences in accordance with molten iron conditions or operating conditions of respective ironworks, the composition of converter slag generally belongs to the composition range mentioned in the following TABLE 1.

TABLE 1

| Component | CaO | SiO₂ | FeO | MgO | MnO | Al₂O₃ | P₂O₅ |
|---|---|---|---|---|---|---|---|
| Content (wt %) | 35-45 | 9-15 | 15-26 | 6-12 | 3-5 | 2-4 | 1-3 |

Here, the content of iron oxide (FeO) refers to the total weight percent of Fe-based oxides. Examples of such Fe-based oxides in converter slag include FeO, Fe₂O₃, Fe₃O₄ and combinations of them and other components.

In the implementation of a converter process, an interior temperature of a converter increases due to carbon burn-up and molten iron oxidation. This consequently causes an increase in the temperature of converter slag up to 1600° C. or more after converter blowing. Accordingly, converter slag remains in liquid-phase after completion of the converter blowing.

Most converter slag having the above mentioned composition and temperature condition, however, may result in a problem in that, when the converter slag is mixed with a following charge of molten iron to be refined, impure components, such as phosphor, etc., may be mixed into the molten iron. For this reason, it is normal that converter slag is entirely discharged out of a converter except for a specific amount of slag required for protecting a converter body or for use in refining.

Conventionally, converter slag is treated in such a manner that the slag is discharged from a converter into a slag pot, which is located below the converter, to be temporarily received in the slag pot, and thereafter, is again discharged from the slag pot into a slag yard. In this conventional treatment, a large amount of water is sprayed onto the slag discharged from the slag pot, to cool and solidify the slag. Then, the solidified slag is subjected to crushing, such that iron in the slag is separated from the slag via appropriate sorting such as magnetic force sorting, etc., so as to be reused as iron source. However, the residual slag, from which iron was removed, has no special use purpose, and thus, is mainly buried in the ground or used as aggregate for use in road pavements, etc. Also, although the converter slag is cooled as water is sprayed thereto, such slag cooling may be performed slowly because of low heat transfer efficiency and high heat capacity thereof. FIG. 1 illustrates compositions of converter slag at equilibrium states, and FIG. 2 illustrates a slag cooling course to obtain the compositions of converter slag.

As can be seen from the above TABLE 1 and FIGS. 1 and 2, main components of converter slag include CaO, SiO₂ and Fe-based oxides. These oxides maintain stable 3CaOSiO₂ components in their molten state, but may generate 2CaOSiO₂ upon solidification. This results in generation of free CaO, and the corresponding phase of converter slag has differentiation/expansion characteristics. In this way, the converter slag contains a large amount of free lime (i.e. free CaO referring to single-phase CaO), and the free lime tends to produce calcium hydroxide (Ca(OH)₂) when it comes into contact with water in a later process, as represented by the following EQUATION 1.

CaO+H₂O=Ca(OH)₂ EQUATION 1

Calcium hydroxide has a larger volume than free lime, and is characterized to be powdered, rather than forming a lump. Therefore, when calcium hydroxide is used as a roadbed material, etc., it may cause a problem of road pavement swell, etc., and also, has a risk of air pollution in its powdered state. Furthermore, calcium hydroxide is water soluble, and therefore, may cause a problem of soil pollution by increasing the pH of soil.

For these reasons, in spite of the fact that a large amount of converter slag, more than average eighty millions a year, is generated throughout the word, converter slag has low utility for use in civil engineering aggregate and roadbed material due to instability thereof. To solve this problem, it is essential to previously expand converter slag via a stabilizing or aging treatment, prior to using it.

Although a variety of methods for stabilizing and recycling converter slag have been proposed to solve the above described problems, no techniques considering technical and economical aspects have been developed up to now. As a prior art solution for the above described problems, for example, S. Morishita, et al. worked in Japan Sumitomo Metal Industries, Ltd., developed a novel steam aging technique, which is called Sumitomo Kawasaki Aging Process (SKAP) as disclosed in technical report SEAISI Quarterly of January 1997, p. 37. However, the steam aging technique is uneconomical and has a limit to process a large amount of slag. In another prior art solution, for the purposes of stabilizing converter slag and reducing the amount of CO₂ down to a level satisfying environmental restrictions, slag stabilizing techniques have developed for transforming CaO in converter slag into CaCO₃ via carbonation using CO₂ gas that is blown to the converter slag, as disclosed in: 7^{th} Conference of the European Ceramic Society of 2001, p. 879 (T. Takahashi and M. Fukuhara) [Key Engineering Materials, vols. 206-213 (2002) p. 879; Adv. Cem. Res., 12 (2000) p. 97 (T. Isoo, T. Takahashi, N. Okamoto and M. Fukuhara; Am. Ceram. Soc. Bull., 80 (2001) p. 73 (T. Isoo, T. Takahashi and M. Fukuhara); and Materia Japan, 39 (2000) 7 p. 594 (M. Fukuhara and T. Takahashi). Stabilized slag resulting from the above techniques has been proved to be eco-friendly. Also, as a result of performing an experiment for pouring the stabilized slag into sea, it could be found that the stabilized slag can enrich plankton, thus being proposed as a representative example of slag recycling. However, actually, the conventional techniques have a complex necessity for various troublesome facilities and technical processes such as crushing, compression, molding, etc., which are required for the fabrication of large-sized slag blocks. Accordingly, it can be said that the conventional techniques are impractical and uneconomical.

As a further prior art solution, several techniques for self-recycling of converter slag generated in steelworks have reported. For example, there was an attempt to stabilize free CaO and P₂O₅, which are considered to be key points of slag recycling by some researchers, by use of flux materials such as Al, Si, etc., as known from: 84^{th} Steelmaking Conference Proceedings 84 (2001) p. 317 (E. Cruz, J. Neto, F. Neto, E. Ukai and J. Tosetti; and 78^{th} steelmaking Conference Proceedings 78 (1995) p. 79 (J. Y. Ryu, C. M. Lee, Y. C. Yoon, J. I. Kim, B. D. You, J. J. Park). However, these stabilizing techniques require a reaction temperature more than 1400° C., and therefore, has failed to be put to practical use in the views of mass production and economy. Considering yet another prior art solution, under a conclusion that converter slag is recyclable with flux materials in steelworks if phosphor in the converter slag is removed, a few researchers attempted to cool converter slag at a greatly lower cooling rate than a conventional cooling rate, and thereafter, to remove phases containing phosphorus oxides by use of floating and solution extrusion methods, based on a discovery that most phosphorus oxides are segregated into phases of 2CaOSiO₂ upon solidification, as known from: I&SM, Jan. 16 (1989) p. 47 (T. Fujita and I. Iwasaki); and The Minerals, Metals & Materials Society, (1990) p. 429 (E. Fregeau-Wu, S. Pignolet-Brandom and I. Iwasaki). However, this technique also couldn't be put to practical use because mass treatment thereof is impossible.

Other technical developments and attempts for utilizing slag in cement, glass industries, etc. in various manners have been achieved, but, in fact, a recyclable amount of slag is extremely limited due to the above mentioned problems.

### DISCLOSURE

### Technical Problem

Therefore, the present invention has been made in view of the above problems, and it is an object of the present invention to provide a method for minimizing generation of free lime by eliminating instability of converter slag that is caused upon cooling.

It is another object of the present invention to provide a method for minimizing an amount of free lime in converter slag via appropriate pretreatments, based on converter slag conditions or operating conditions of a converter.

### Technical Solution

In accordance with an aspect of the present invention, the above and other objects can be accomplished by the provision of a method for stabilizing slag comprising: allowing molten slag to fall; injecting high-pressure gas to falling molten slag to separate the molten slag into fine droplets; and quenching the fine droplets with the injected gas and surrounding atmosphere.

In this case, preferably, a rate of mass flow rate of the slag (J_{slag})/mass flow rate of the injected gas (J_{gas}) is in the range of 0.4 to 1.7.

Preferably, the gas is injected from at least one nozzle having a single hole or multiple holes, or a Laval-type nozzle.

Preferably, the gas, injected from the nozzle having a single hole or multiple holes, has an injection linear velocity in the range of 50 m/s to 90 m/s at a tip end of the nozzle.

Preferably, the gas, injected from the Laval-type nozzle, has an injection linear velocity in the range of Mach 1.5 to 3 at a tip end of the nozzle.

Preferably, the injected gas is selected from one of air, nitrogen, argon and helium.

Preferably, the cooled slag has an average size in the range of 200 μm to 5 mm.

Preferably, the method may further comprise spraying water mist to the slag behind the area of gas injection.

Preferably, the molten slag prior to being treated has a temperature in the range of 1400° C. to 1550° C.

Preferably, the molten slag is converter slag or electric arc furnace slag.

Preferably, if the molten slag is converter slag and an N₂ splash coating is performed using the slag in a converter, only a part of the slag, which is discharged prior to performing the N₂ splash coating, is used as the converter slag. This is advantageous to achieve a desired temperature of the slag.

Preferably, if the molten slag prior to being treated has a temperature of 1600° C. or less at a time point when the slag is discharged from the converter into a slag pot, a slag stabilizing course is performed just after discharge of one charge.

Preferably, carbon particles having a sphere-equivalent diameter in the range of 30 μm to 150 μm is injected to the falling molten slag, along with the injected gas.

In accordance with another aspect of the present invention, there is provided a material manufactured by a slag stabilizing method comprising: allowing molten slag to fall; injecting high-pressure gas to falling molten slag to separate the molten slag into fine droplets; and quenching the fine droplets with the injected gas and surrounding atmosphere, wherein the material has a particle size in the range of 200 μm to 5 mm, and may be utilized as constructional materials such as sand, carrier, cement, concrete, etc., waste water treatment materials, iron source or substitute for free lime in iron-making processes, slag preparing agent, etc.

### Advantageous Effects

With the present invention, stabilization of converter slag can be achieved by restricting generation of free lime during cooling, resulting in novel solid-phase converter slag particles usable for various use purposes. Further, the present invention can provide a converter slag stabilizing method regardless of status of converter slag by providing a converter slag preparation method corresponding to a variety of converter slag conditions.

Converter slag manufactured by the present invention may be utilized as constructional materials such as sand, carrier, cement, concrete, etc., waste water treatment materials, iron source or substitute for free lime in steel-making processes, slag preparing agent, etc.

### DESCRIPTION OF DRAWINGS

The above and other objects, features and other advantages of the present invention will be more clearly understood from the following detailed description taken in conjunction with the accompanying drawings, in which:

FIG. 1 is an explanatory view illustrating a cooling path in relation with converter slag compositions represented on a CaO—SiO₂ dual-phase diagram;

FIG. 2 is a flow chart illustrating generation and hydration of free lime in a conventional slag cooling process;

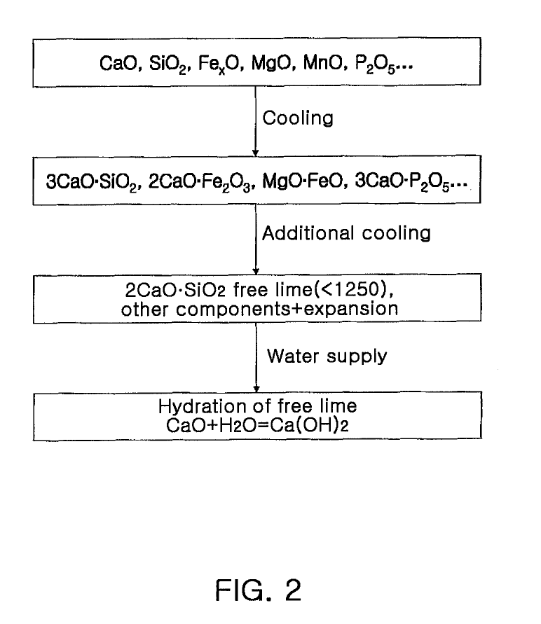

FIG. 3 is a diagram illustrating implementation of a converter slag stabilizing method using an induction melting furnace according to the present invention;

FIG. 4 is a diagram illustrating the shape variation of converter slag in a movement path thereof when the converter slag is quenched via injection of high-speed gas;

FIGS. 5A and 5B are comparative photographs, respectively, illustrating quenched spherical slag particles manufactured by the converter slag stabilizing method according to the present invention and slowly-cooled bulk shaped slag of the prior art;

FIG. 6 is a graph illustrating particle size distribution of the quenched slag, which is manufactured and recovered according to the present invention;

FIGS. 7A and 7B are photographs illustrating the surface shape of the quenched spherical slag particles, which are manufactured by the method according to the present invention and observed with a scanning electron microscope (SEM) after being ground at a fixed mounting position;

FIGS. 8A and 8B are graphs, respectively, illustrating X-ray diffraction analysis results of slowly cooled converter slag of the prior art and quenched converter slag manufactured by the method of the present invention;

FIGS. 9A and 9B are photographs, respectively, illustrating extraction of calcium hydroxide at a surface of a beaker in which one of the slowly cooled converter slag of the prior art and quenched converter slag manufactured by the method of the present is received for a predetermined period along with water;

FIG. 10 is a graph comparing pH variations of water in a state wherein each of the slowly cooled converter slag of the prior art and quenched converter slag manufactured by the method of the present invention is mixed with the water;

FIG. 11 is a graph illustrating a calculated amount of molten free lime after the lapse of 7 days from a time point when converter slag, which is slowly cooled in a conventional manner or is quenched using gas having a flow rate of 90 l/min or 110 l/min, is mixed with water; and

FIG. 12 is a view of a ternary phase diagram illustrating the area of final slag composition based on slag cooling conditions.

### BEST MODE

Hereinafter, the present invention will be explained in detail. Although the following description exemplifies converter slag, it should be understood that a method of the present invention is sufficiently applicable to electric arc furnace slag so long as the electric arc furnace slag satisfies temperature and composition conditions that will be defined hereinafter.

[Quenching of Slag]

As a part of efforts to solve the above described prior art problems, inventors of the present invention found that a conventional method for cooling converter slag has a low cooling rate due to low heat transfer efficiency of slag, and thus, resulting in production of 2CaO—SiO₂ rather than 3CaO—SiO₂, therefore generation of free lime due to extracted extra CaO. On the basis of this discovery, there is a necessity for a method for stabilizing converter slag without causing the above described problems.

Differently from conventional methods in which slag is first piled up and then cooled, the present invention is characterized in that high-speed gas is injected to slag, which is vertically discharged toward the ground surface, to separate the slag into fine droplets by kinetic energy thereof. Such a slag droplet is efficient to achieve high heat emission from a surface layer thereof, and consequently, can restrict generation of 2CaO—SiO₂ due to slow cooling. The slag may fall directly from a slag storage container, such as a slag pot, or by way of a tundish for the regulation of flow rate.

In this case, a correlation between the amount of slag discharged and the amount of injected gas is important. For example, if a greatly larger amount of slag than the amount of injected gas is discharged at a time, it is difficult to maintain quenching conditions sufficient to restrict a phase transformation of slag in the course of cooling. This may generate a large amount of free CaO and 2CaO—SiO₂ phases, and consequently, makes it impossible for converter slag particles obtained by the method of the present invention to acquire the above described objects. On the other hand, if a greatly smaller amount of slag than the amount of injected gas is discharged, a treatment time is extended and consumption of gas increases excessively, resulting in inefficient and uneconomical treatment. Accordingly, it is essential to set an appropriate rate of discharge amount of slag/amount of injected gas. As a result of measuring the ratio of mass flow rates (g/s) of slag and gas using a small-scale experimental furnace, the ratio of mass flow rate of converter slag (J_{slag})/mass flow rate of gas (J_{gas}) may be preferably in the range of 0.4 to 1.7, and more preferably, in the range of 0.5 to 1.7. If the ratio exceeds the above range, it is impossible to reach target quenching conditions, whereas, if the rate is below the above range, the size of spherical converter slag particles decreases greatly by excessive quenching. This may result in excessive consumption of gas.

The size of spherical converter slag particles obtained under the above mentioned conditions averages 500 μm, and belongs to the range of 200 μm to 5 mm. Although the size of the spherical converter slag particles may be preferably in the range of 200 μm to 2 mm, and more preferably, in the range of 500 μm to 1 mm. It can be said that the above mentioned range of 200 μm to 5 mm is acceptable because a gas injection position, slag discharge position, etc. may be changed in various manners as occasion demands. Of course, it should be understood that the average size of slag particles as defined herein refers to an average size of an outermost part of converter slag except for a residual slag part, which exists at a free falling location, and a gravel part which is formed of a mixture of iron and slag and adapted to be recovered from a location spaced apart from a gas injecting facility by a moderate distance.

Among several steps included in the method of the present invention, in a stage wherein the converter slag is kept in molten state in a slag yard, kinds of gas, amount of injected gas, and configuration of a gas injecting facility become the most important factors. Hereinafter, ranges of these factors will be explained in detail.

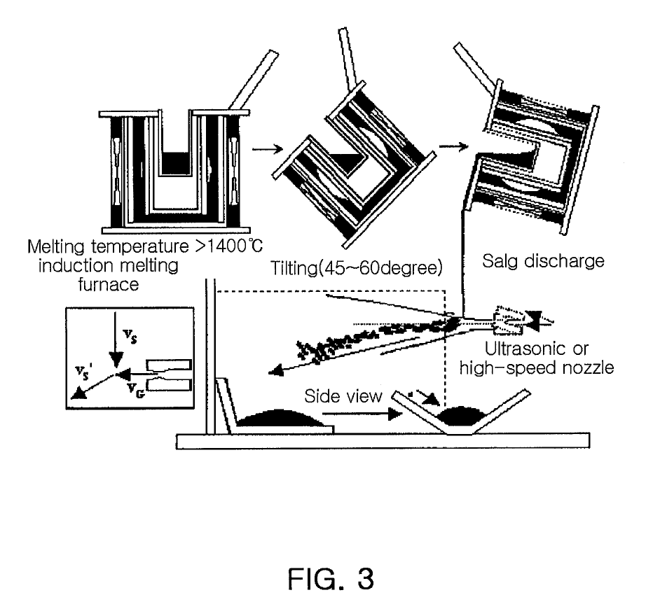

FIG. 3 schematically illustrates a gas injecting facility for use in a quenching course. For convenience sake, the quenching course is explained in such a manner that, after converter slag is melted in an induction furnace and discharged therefrom, gas is injected to the discharged molten slag by use of a nozzle. Generally, converter slag has a melting point in the range of 1350° C. to 1400° C. Thus, assuming that the molten slag solidifies instantly at a temperature of 1300° C. when it is quenched at a temperature of approximately 1450° C., the gas for the quenching is argon gas and the mass flow rate of the molten slag is 3.5 g/s, it can be calculated from the following TABLE 2 that the argon gas has to have a mass flow rate of approximately 1.56 g/s. This means that the gas has to have a flow rate of appropriately 53 l/min on the basis of a back pressure of 100 psi.

TABLE 2

| Material balance equation | ${C}_{p , s} \frac{{dm}_{s}}{dt} {T}_{m} + {C}_{p , g} \frac{{dm}_{g}}{dt} {T}_{g} = {C}_{p , s} \frac{{dm}_{s}}{dt} {T}_{s} + {C}_{p , g} \frac{{dm}_{g}}{dt} {T}_{s}$ | | | |
|---|---|---|---|---|
| | Here, Cp is specific heat, | | | |
| | low subscripts s and g are slag and gas, respectively, | | | |
| | dm/dt are mass flow rates, | | | |
| | Tm is temperature of molten slag, | | | |
| | Tg is temperature of injected gas, and | | | |
| | Ts is solidifying temperature of slag | | | |
| Specific | A | B | C | Specific heat equation |
| heat | | | | |
| coefficient | | | | |
| CaO | 6.104 | 0.000443 | −104700 | (A + BT + CT²)R |
| SiO₂ | 4.871 | 0.005365 | −100100 | |
| Fe₂O₃ | 11.812 | 0.009697 | −197600 | |
| Converter | 7.842 | 0.004184 | −135053 | |
| slag | | | | |
| Ar gas | 20.8 | | | specific heat of Ar is |
| | | | | represented as a |
| | | | | constant |

Here, the converter slag has a composition consisting of 40 weight percent of CaO, 10 weight percent of SiO₂, 25 weight percent of Fe₂O₃ and other impurities including MgO, Al₂O₃, P₂O₅, etc. Also, from the above equation, the density of Ar can be calculated as 0.001783 g/cm³. Differently from converter slag in which Fe oxides have a variety of phases including FeO, Fe₂O₃ Fe₃O₄, etc., the converter slag, which was quenched in air, mainly contains Fe₂O₃. Also, in the above equation, J/m·° C. is used as the unit of specific heat.

Since entire energy of the injected gas is not transmitted to the converter slag discharged, with knowledge obtained by experiments and experience, when a rectangular slit-shaped nozzle having a width of 20 mm and a height of 2 mm is used to inject air, an actual required flow rate of the air may increase up to approximately 90 l/min. Accordingly, it can be understood that, when considering energy transmission efficiency obtained by experiments and experience, the most preferable mass flow rate of injection gas for the quenching of converter slag is in the range of 90 l/min to 110 l/min, under the assumption that the mass flow rate of the converter slag is 3.5 g/s. In this case, the converter slag stabilizing method of the present invention may comprise the step of converting a determined essential treatment amount of slag into a mass flow rate, confirming the mass flow rate of desired basic gas from the above TABLE 2, determining the kind of a nozzle to be used from the confirmed mass flow rate, and calculating a flow rate of gas. In the present invention, a distance between the nozzle and the molten converter slag that is allowed to fall freely is not specially defined. However, since the farther the distance, the less the energy transmission efficiency of gas to the converter slag, it is desirable that a gas injecting facility be installed as close as possible so long as a tip end of the nozzle does not come into contact with the discharged slag. Also, it is desirable that a gas injecting height be set as high as possible, in order to allow the gas to be injected to the slag which maintains the maximum molten state. The injection gas may be selected from among air, nitrogen, argon, helium, etc, and the heat transfer efficiency of these gases increases in the sequence of air or nitrogen<argon<helium. Although it is advantageous to use helium in the view of heat transfer, it is desirable to use air or nitrogen in the view of environment and economical efficiency.

The above described gas conditions, such as the mass flow rate, etc. are set on the basis of gas having a room temperature (for example, 25° C.), and it will be understood for those skilled in the art that the flow rate of gas may be changed depending on the temperature of gas by use of the calculation method described in the above TABLE 2. However, when gas is used without being cooled or heated under special conditions, the above described gas mass flow rate range of the present invention is directly applicable without any serious problems.

Considering the gas injection nozzle, it may be preferably a conventional straight nozzle having a single hole suitable to obtain spherical converter slag particles having a size of approximately 500 μm. However, when it is desired to increase the treatment amount of slag, a jet nozzle in the form of a Laval-type nozzle may be used to achieve improved gas cooling effect, or a nozzle having multiple holes may be used. When using the nozzle having a single hole or multiple holes, a linear velocity of gas at a tip end of the nozzle may be preferably in the range of 50 m/s to 90 m/s, and more preferably, in the range of 60 m/s to 90 m/s. When using the jet nozzle, the linear velocity may be in the range of Mach 1.5 to 3 in consideration of reduction in the velocity of gas from the nozzle to the slag.

When it is desired to cool slag with a higher cooling rate, the fine slag droplets separated by the gas maybe subjected to an additional cooling course. An example of the additional cooling course includes spraying of water mist. When using the water mist, the flow rate of the water mist may be preferably less than 15% of the mass flow rate of gas (J_{gas}), and more preferably, in the range of 5% to 15% of the mass flow rate of gas (J_{gas}), on the basis of volume. If the flow rate of the water mist exceeds the above range, water may remain on the slag droplets after spraying, and fine strong-alkalic dust particles in converter slag are melted in the water, resulting in strong-alkalic water solution. This causes environmental pollution due to the strong-alkalic water, and runs counter to the recycling object of the present invention. On the contrary, if the flow rate of the water mist is below the above range, effect of the additional cooling course may be insufficient.

Summarizing the above description, the method for stabilizing converter slag according to the present invention is characterized in that, if converter slag having an appropriate temperature range is discharged from a slag pot to fall freely, high-speed gas is injected to free falling converter slag in molten state, to separate the converter slag into fine slag droplets and to allow the slag droplets to be quenched via heat emission from a surface layer thereof. In the method of the present invention, a water mist spraying step may be additionally employed to achieve an improvement in cooling rate. The converter slag, obtained by the converter slag stabilizing method of the present invention, may be divided into three types, based on shapes thereof. Specifically, the converter slag includes: a residual part fallen in the vicinity of a gas injecting facility; a gravel part formed of thermally bonded iron particles and converter slag and adapted to be spaced apart from the gas injecting facility by a moderate distance; and an outermost part scattered on the farthest location from the gas injecting facility. These respective parts of the converter slag may be selectively utilized for appropriate use purposes in consideration of their different characteristics.

[Acquisition of Preferred Slag Conditions]

To manufacture stabilized converter slag having a variety of characteristics as stated above, it is necessary to cause free falling of molten converter slag from the slag pot. For this, the converter slag has to maintain a sufficient liquidity until it is discharged from the slag pot, for facilitating easy discharge thereof. To achieve such a sufficient liquidity, at a time point when being discharged from the slag pot, the converter slag has to have a temperature of 1400° C. or more and T. Fe in the slag has to be more than 15 weight percent or more. Preferably, the converter slag may have a temperature of 1430° C. or more, and more preferably, may have a temperature of 1450° C. or more, but not exceeding 1550° C. This is because excessively high temperature needs a very fast linear velocity at an outlet of the nozzle, thus making it difficult to maintain desired quenching conditions suitable to restrict phase transformation. In the case of T. Fe, it has no problem due to a high content thereof within the composition range of general converter slag, and therefore, the upper limit of T. Fe is not specially limited.

Meanwhile, when a splash coating using N₂ gas, which was developed for the purpose of increasing the lifetime of a converter, is performed, cold nitrogen gas jets are directly injected to the slag before the slag is discharged from the converter. This results in a considerable reduction in sensible heat of the slag, and therefore, a great part of the slag may be solidified already prior to reaching a slag yard. To solve this problem, it is desirable that approximately a half of the converter slag remain in a converter, whereas the remaining part be removed from the slag pot before splash coating after refining. This allows only the removed part of the converter slag to be used in stabilizing treatment.

In some steelworks, instead of completing an oxygen blowing when a carbon content at an end point of a blowing reaches the conventional range of 0.03% to 0.05%, the blowing may be completed at the point when the carbon content has a higher value, for example, 0.4% or more. In the meantime, this may cause the slag to be removed only after a temperature thereof is lowered below approximately 1600° C. In this case, instead of receiving slag of three charge of blowing as general receiving process does, it is desirable that the slag is received into the slag pot after only one charge of blowing, and immediately, the slag pot is transferred to allow the slag to be kept in molten state when being discharged at the slag yard. Namely, if the temperature of slag is very low at the termination time point of blowing, the method of the present invention may further comprise the step of blowing oxygen gas to the slag to oxidize the residual slag to have an FeO phase, so as to increase not only the density of T. Fe, but also the temperature of the slag by use of oxidation heat, thereby keeping the slag in molten state.

Meanwhile, the method of the present invention may further comprise the step of restricting the transfer of heat to the outside by use of a slag pot cover in the course of transferring the slag pot to the slag yard, in order to minimize a temperature drop, and consequently, to keep the slag in molten state.

[Shape Control of Slag Particles]

If the molten converter slag is quenched in the above described manner, generally, spherical slag particles having a black, smooth and clean surface are obtained. This is a result of minimizing a surface tension of slag in the state of droplets.

However, in particular fields such as waste water treatment, it is necessary to increase the surface area of the slag particles to be as large as possible because the larger the specific surface area, the greater the treatment efficiency. An efficient method for increasing the surface area of slag particles is to provide the slag particles with a porous surface.

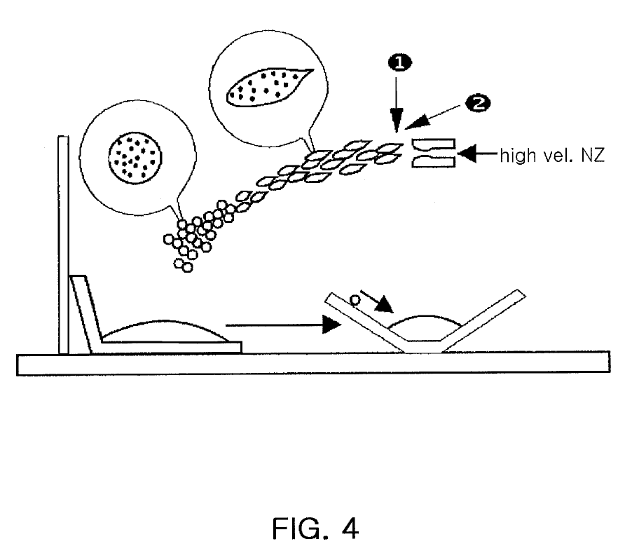

To obtain the porous particles, as shown in FIG. 4, it is efficient to blow carbon powder having a sphere-equivalent diameter of 30 μm or more to the slag along with the gas, so as to allow the slag to be suitable for the waste water treatment. If the size of the carbon powder is excessively large, it may cause an insufficient increase in the surface area of converter slag particles, and therefore, the carbon powder preferably has a size of 150 μm or less. The blown carbon powder, which remains on the surface of slag droplets, is removed by oxidation in a later droplet cooling process, resulting in formation of pores.

Also, to obtain the above described specific surface area, the method of the present invention may further comprise the step of sintering slag particles having a size of 100 μm or less, which are manufactured by blowing super high speed gas (i.e. gas having a flow rate exceeding the upper limit of a gas injecting flow rate as defined in the present invention) or gas jets, at a temperature of 900° C. or less by use of a binder, so as to obtain particles having a size of 1 mm to 10 mm.

The spherical converter slag particles, manufactured via the above described steps of the present invention, constitute novel converter slag, which has the same composition as that of prior art converter slag, but contains different phases therein from those of the prior art converter slag. That is, the converter slag manufactured by the present invention is stable converter slag containing free lime of only 1% or less and having no hydration and powdering reactions. Also, the converter slag takes the form of nearly spherical particles having a smooth or porous surface.

Since the slag particles of the present invention are stable particles not causing hydration or powdering as stated above, they may be utilized as constructional materials, such as sand, carrier, cement, concrete, etc., waste water treatment material, iron source or substitute for free lime in iron-making processes, slag preparing agent, etc.

The present invention is not essentially limited to converter slag, but is applicable to electric arc furnace slag, etc. Such an electric arc furnace slag is characterized in that it consists of 30-45% of CaO, 15-30% of SiO₂, 20% or more of T. Fe, and other Cr₂O₃, MgO, MnO, TiO₂, etc., and a basicity of CaO/SiO₂ is 1-3.

[Mode for Invention]

Now, the present invention will be explained in more detail with reference to the following example. Here, it should be noted. that the following example is merely one exemplary embodiment of the present invention proposed to explain the present invention in more detail, and thus, the technical range of the present invention is not limited to the following example.

### EXAMPLE

To manufacture molten converter slag, as shown in FIG. 3, 300 g of converter slag was heated in an induction furnace for 4 hours. Here, a crucible made of magnesia was used. The converter slag already contains MgO in a saturated density, and therefore, there is no risk of a reaction between the converter slag and the magnesia crucible, and accordingly, there is substantially no change in composition of the converter slag due to mixing of MgO. In the above heating step, the temperature of the converter slag was maintained constantly after being raised to the temperature of 1500° C. After confirming that the converter slag is in molten state, the molten slag was discharged such that air is blown to the discharged molten slag from the lower side of the slag, in order to manufacture spherical converter slag particles. In this case, the flow rate of air was set to approximately 110 l/min. Also, the discharge flow rate of the slag was kept at approximately 3.5 g/s. In this case, the converted mass flow rate value was approximately 1.13 belonging to the range of the present invention. The composition of the used converter slag is described in the following TABLE 3.

TABLE 3

| Component | CaO | SiO₂ | FeO | MgO | MnO | Al₂O₃ | P₂O₅ |
|---|---|---|---|---|---|---|---|
| Content (wt %) | 41 | 10 | 18 | 9 | 4 | 3.5 | 2.2 |

Once the converter slag is molten and gas begins to be injected, the induction furnace itself was initially tilted by a tilting angle of 45° to prepare discharge of the slag, as shown in FIG. 3. Then, if it is determined whether or not a discharge position of the slag corresponds to a gas injecting position, discharge of the slag was performed. In this case, a slit shaped copper tube having a width of 20 mm and a height of 2 mm was used as a gas nozzle. To prevent a temperature drop of the slag prior to being discharged as much as possible, a distance between the slag discharge position and the gas nozzle was maintained at 10 mm. Also, the nozzle was maintained at a height of 10 mm from the bottom of the induction furnace. Meanwhile, a L-shaped iron plate having a width of 60 cm, a height of 60 cm, and a length of 2.4 m was prepared at a location opposite to the gas nozzle to collect the resulting spherical converter slag particles.

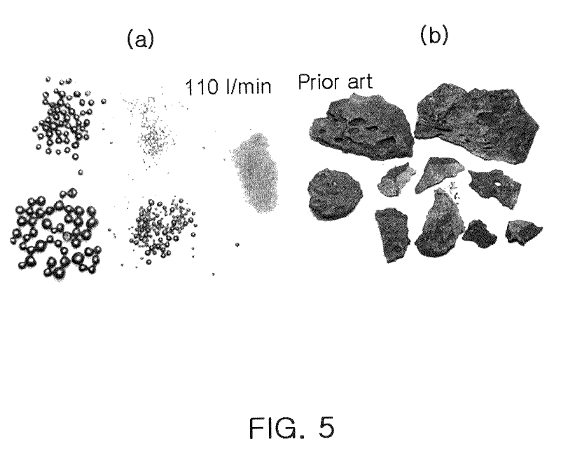

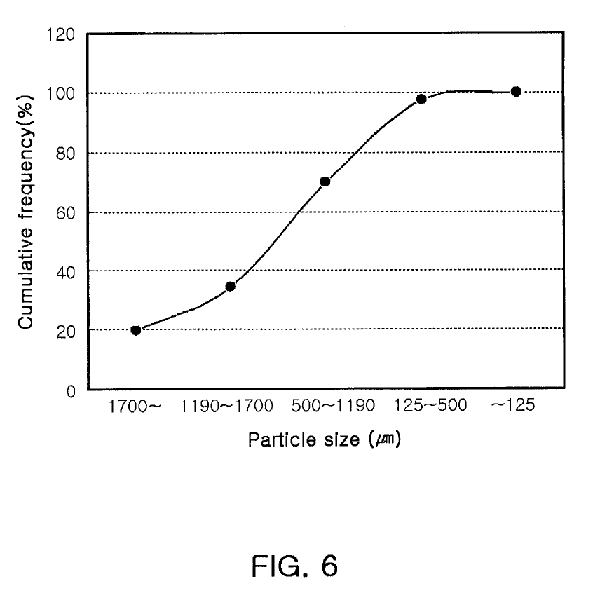

FIGS. 5A and 5B illustrate the spherical converter slag particles manufactured by the present invention and the prior art converter slag (i.e. slowly cooled slag), respectively. As shown in the drawings, the particles manufactured by the present invention had a spherical shape, and were distributed as shown in FIG. 6. If the size of particles exceeds 1.7 mm, the particles have an atypical shape, rather than having a spherical shape, and take the form of iron particles.

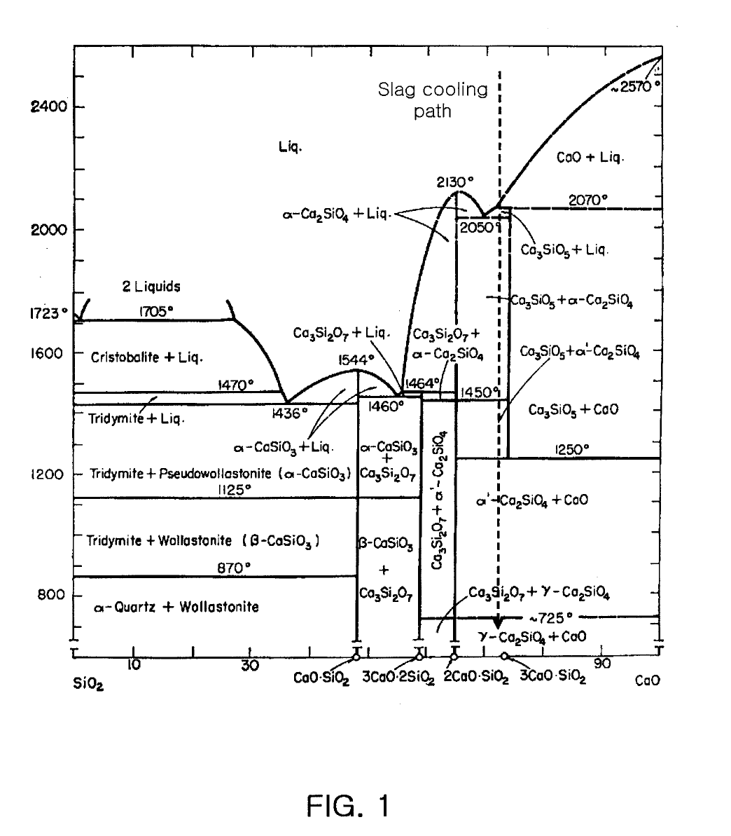

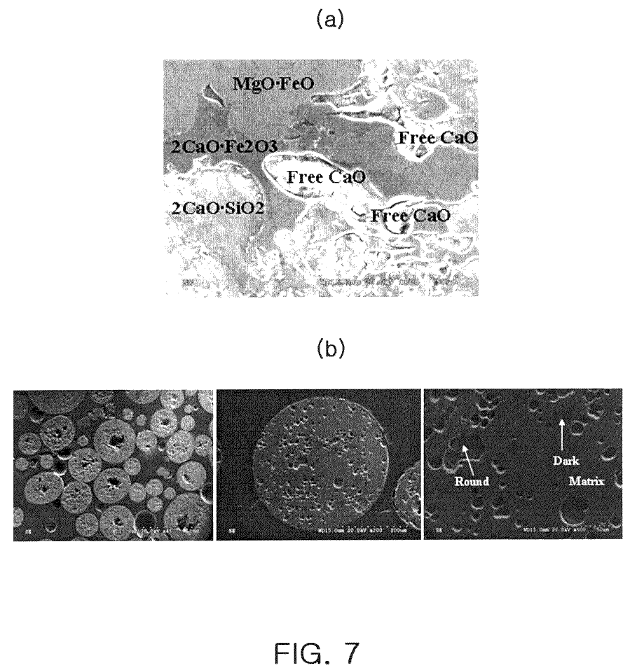

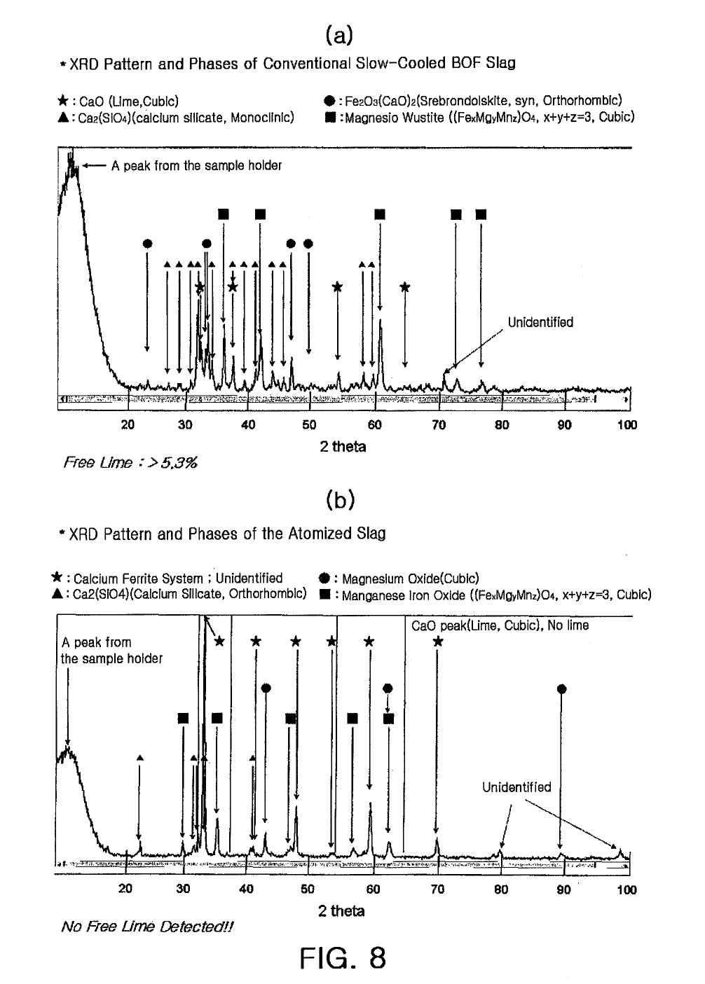

To show effects of stabilization of converter slag according to the present invention, phases of prior art converter slag (slowly cooled slag) and converter slag particles of the present invention were analyzed using a SEM, and the results were shown in FIGS. 7A and 7B. As shown in FIGS. 7A and 7B, it was found that the prior art converter slag (slowly cooled slag) contains free CaO caused by various phase-separations as shown in FIG. 1, whereas the converter slag of the present invention has no free CaO. This could be seen via X-ray diffraction (XRD) as shown in FIGS. 8A and 8B. That is, from the drawings, it can be understood that CaO, which is contained in the prior art converter slag, is not detected in the spherical converter slag particles manufactured by the present invention.

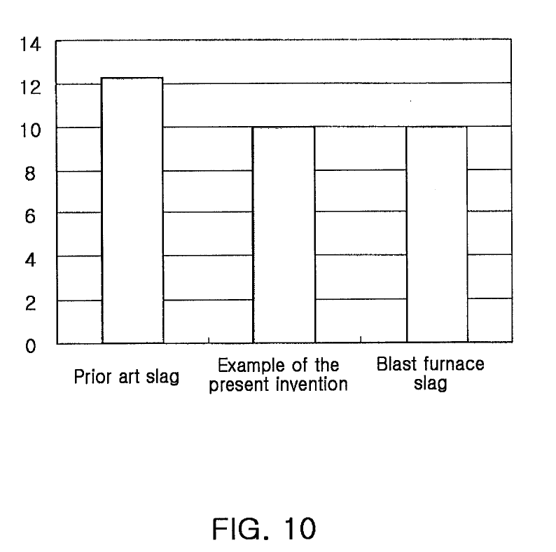

Also, to determine whether or not the problem of increased pH due to free lime was solved, the prior art converter slag and the spherical converter slag particles manufactured by the present invention were charged into different beakers, respectively. Each beaker was filled with distilled water. Then, a pH increase experiment was performed in such a manner that each of the prior art converter slag and the spherical converter slag particles of the present invention was mixed with the distilled water at a ratio of water to slag of 80:1 at a room temperature. In this experiment, the amount of CaO can be measured on the basis of the resulting pH increase. Each of the prior art converter slag and spherical converter slag particles of the present invention was left for 7 days in the mixed state with the distilled water within the beaker, and the pH of the distilled water received in each beaker was measured frequently. As a result, it could be found that the prior art converter slag has pH of 12 or more, whereas the spherical converter slag particles of the present invention has pH of 10 or less. The pH range of the present invention is less than the pH range of blast furnace slag having a low basicity as shown in FIG. 10, and thus, belongs to an allowable range.

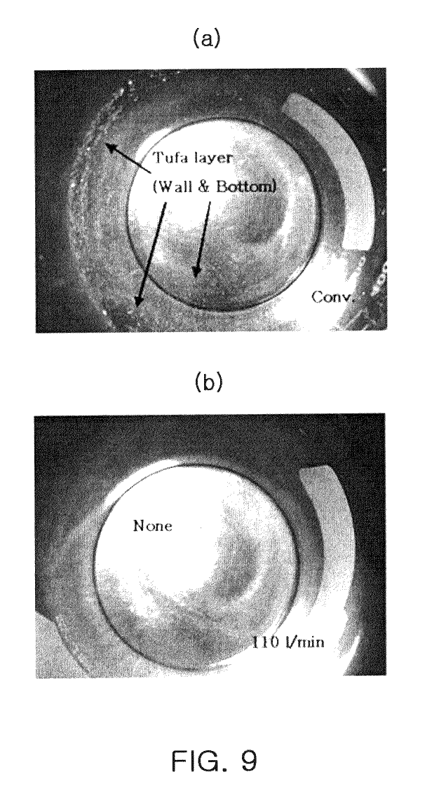

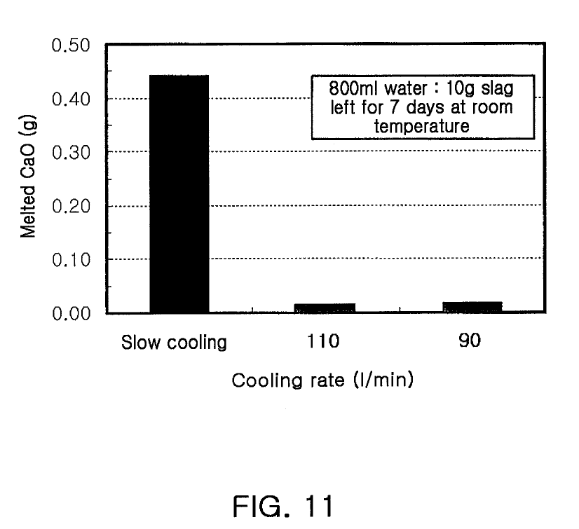

FIGS. 9A and 9B illustrate observation results with respect to states of the respective beakers used in the above experiment. In the case of the prior art converter slag as shown in FIG. 9A, Ca⁺ and (OH)⁻ ions were saturated in the slag, thus causing extraction of calcium hydroxide (Ca(OH)₂). On the other hand, the spherical converter slag particles of the present invention as shown in FIG. 9B were clean without extraction of a specific phase. This is possible as a result of restricting separation of phases and formation of CaO phase with respect to the converter slag having the same components as the prior art converter slag. Converting the amount of CaO into percentage with respect to the amount of the water received in the corresponding beaker, it was found that the prior art converter slag has 5% or more CaO, whereas the converter slag particles of the present invention only has 0.5% CaO as shown in FIG. 11. These results agreed with the analysis results of the XRD.

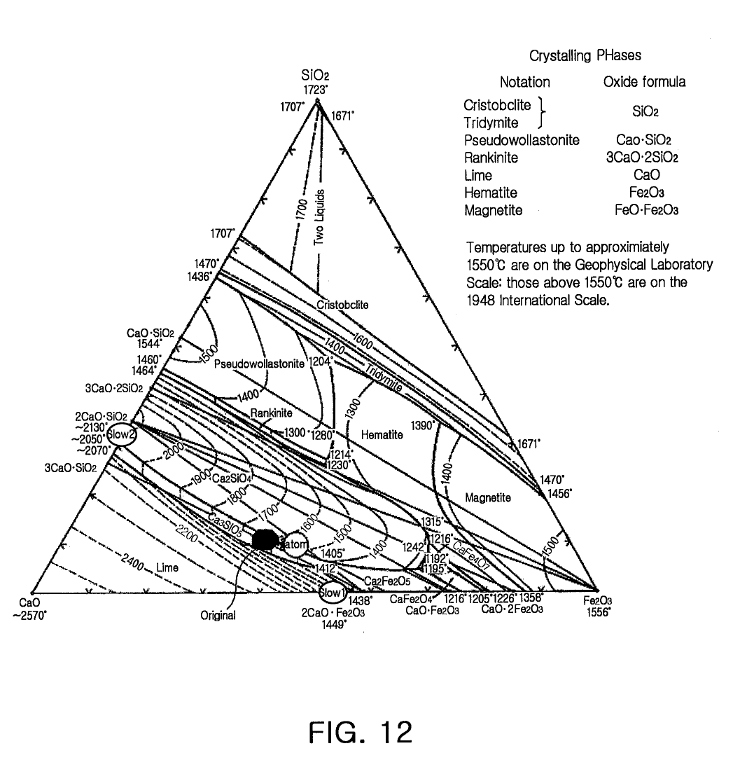

Finally, phase restriction effects based on the analysis results of the SEM and XRD are illustrated in FIG. 12 in view of ternary phase diagram. As could be seen from the drawing, conventionally, a part of molten converter slag was separated into two main phases (as designated by the white circles “slow 1” and “slow 2”) while being slowly cooled in a liquid-phase region (as designated by the black circle “Original”), and the remaining part formed MgO·FeO phases and free CaO. On the other hand, the spherical converter slag particles of the present invention formed a main phase in a region close to the liquid-phase composition range, and thus, could restrict phase transformation while being solidified from liquid-phase to solid-phase.

As proved from the above various analysis results, the present invention can achieve stabilization of converter slag. Also, it can be seen that the resulting stabilized spherical slag particles are recyclable in various use ways as stated above in relation with the configuration range and effects of the present invention.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A method for stabilizing slag comprising:
allowing molten slag having a temperature in the range of 1400° C. to 1550° C. to fall;
injecting high-pressure gas to failing molten slag to separate the molten slag into fine droplets; and
quenching the fine droplets with the injected gas and surrounding atmosphere:
wherein a ratio of mass flow rate of the slag (J_{slag})/mass flow rate of the injected gas (J_{slag}) is in the range of 0.4 to 1.7, and
wherein the gas, injected from the nozzle having a single hole of multiple holes, has an injection linear velocity in the range of 50 m/s to 90 m/s at a tip end of the nozzle

2. A method for stabilizing slag comprising:
allowing molten slag having a temperature in the range of 1400° C. to 1550° C. to fall;
injecting high-pressure gas to failing molten slag to separate the molten slag into fine droplets; and
quenching the fine droplets with the injected gas and surrounding atmosphere:
wherein a ratio of mass flow rate of the slag (J_{slag})/mass flow rate of the injected gas (J_{slag}) is in the range of 0.4 to 1.7, and
wherein the gas, injected from the Laval-type nozzle, has an injection linear velocity in the range of Mach 1.5 to 3 at a tip end of the nozzle.

3. The method according to claim 1, wherein, if the molten slag is converter slag and an N₂ splash coating is performed using the slag in a converter, only a part of the slag, which is excluded prior to performing the N2 splash coating, us used as the converter slag.

4. The method according to claim 1, wherein carbon particles, having a sphere-equivalent diameter in the range of 30 μm to 150 μm, is injected to the falling molten slag, along with the injected gas.

5. The method according to claim 1, further comprising:
spraying water mist to the slag behind the area of gas injection, wherein mass flow rate of the mist is 5-15% of that of injected gas.

6. The method according to claim 2, wherein carbon particles, having a sphere-equivalent diameter in the range of 30 μm to 150 μm, is injected to the falling molten slag, along with the injected gas.

7. The method according to claim 2, further comprising: spraying water mist to the slag behind the area of gas injection, wherein mass flow rate of the mist is 5-15% of that of injected gas.
